(19) United States
(12) Patent Application Publication
(10) Pub. No.: US 2006/0144262 A1
(43) Pub. Date: Jul. 6, 2006

(54) Marking apparatus for golf ball and stamp for thereof

(76) Inventor: Ji-Sung Koong, Incheon (KR)

Correspondence Address: DUANE MORRIS, LLP;IP DEPARTMENT, 30 SOUTH 17TH STREET, PHILADELPHIA, PA, 19103-4196, US

(21) Appl. No.: 11/205,845

(22) Filed: Aug. 17, 2005

(30) Foreign Application Priority Data
Jan. 3, 2005 (KR) 20-2005-0000069
Jul. 25, 2005 (KR) 20-2005-0021545

(51) Int. Cl. B41F 17/34; B41F 17/30

(52) U.S. Cl. 101/42; 101/35; 101/DIG. 40

(57) ABSTRACT

A marking apparatus, which is able to mark conveniently a character, a sign and the likes to a golf ball, has a body; and an imprinter joined to the body and having a first curved-surface corresponding to the golf ball. According to the present invention, it is possible to mark a desired character(s), sign(s), or putting lines into a surface of the golf ball.

This application claims the benefit of Korean Utility Model Applications No. 2005-000069, filed on Jan. 3, 2005 in Korea, and No. 2005-021545, filed on Jul. 25, 2005 in Korea, which are incorporated herein by reference for all purposes as if fully set forth herein.

### BACKGROUND OF THE INVENTION

1. Field of the Invention

The present invention relates to a marking apparatus, and more particularly, to a marking apparatus being able to mark conveniently letters, characters, signs, symbols, or diagrams for identifying users into a surface of a golf ball.

2. Discussion of the Related Art

More and more people play golf as a golf popularizes, however, golf rounds in most golf-links are done pressingly because of the lack of golf-links. Especially, a golf team consisting of less than four persons is prohibited in some golf-links. Therefore, at least 4 persons should play golf together.

In such a case, as several persons play golf together, it frequently happens that golfers cannot discern his or her golf ball among neighboring golf balls. Especially, after on-green, such instances are happened more frequently, and therefore, it causes a dispute among golf players.

In order to prevent such dispute, some golfers mark predetermined indications, names, or initials on his or her golf ball with a marker pen. However, it is not easy to mark such indications on a golf ball, which is small and has a curved surface. Especially, marking too large letters on the golf ball results in injuring the beauty of the golf ball and has difficulty in playing golf.

### SUMMARY OF THE INVENTION

Accordingly, the present invention is directed to a marking apparatus for a golf ball that substantially obviates one or more of problems due to limitations and disadvantages of the related art.

An advantage of the present invention is to provide a marking apparatus that marks or indicates conveniently desired letters, characters, signs, symbols, a putting line and the likes on the surface of the golf ball.

Another object of the present invention is to provide a stamp, which has an imprinting material such as an ink, used in the above marking apparatus.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides a marking apparatus for a golf ball, the apparatus comprises a body; and an imprinter joined to the body and having a first curved-surface corresponding to the golf ball.

In accordance with one preferred embodiment of the present invention, the imprinter of the marking apparatus comprises an arc-shaped frame having a predetermined thickness and a curvature corresponding to the golf ball, a type frame joining detachably to the body and having an insert-hole passing through the arc-shaped frame, and a printing type inserted into the insert-hole. Preferably, the insert-hole passes diametrically through the arc-shaped frame and forms a tapered shape toward a center of the arc-shaped frame.

In accordance with another preferred embodiment of the present invention, the imprinter comprises an arc-shaped frame with a predetermined thickness and a curvature corresponding to the golf ball, and a protrusion formed circumferentially in the frame, wherein the imprinter is joined detachably to the body.

It is preferable that the imprinter is fixed at the groove and comprises a plurality of insert-holes. Besides, the marking apparatus further comprises a base which has a second curved surface accommodating the golf ball together with the first curved surfaces. The body is joined to the base by a hinge. Moreover, a pad can be attached to the second curved surface of the base for preventing a movement of the golf ball.

Especially, the base comprises plural second curved surface and the body comprises plural imprinters, wherein each of the plural imprinter is corresponding to each of the second curved surfaces.

Further, the marking apparatus further comprises a stamp spreading an ink to the imprinter, wherein the stamp comprises a stamp body with a curved top corresponding to the first curved surface, a passing portion formed on the stamp body, and a stamp pad attached to the curved top of the stamp body.

In another aspect, the present invention provides a stamp for spreading ink to the imprinter of the marking apparatus, wherein the stamp comprises a stamp body with a curved top corresponding to the first curved surface, a passing portion formed on the stamp body, and a stamp pad attached to the curved top of the stamp body.

Preferably, the stamp body further comprises an ink-accommodating area, wherein the passing portion is connected to the ink-accommodating area. Moreover, the ink-accommodating area is filled with a filter and the stamp pad is made of felt.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exploded perspective view showing a marking apparatus for a golf ball in accordance with one preferred example of the present invention;

FIG. 2 is a perspective view showing a type frame in accordance with the preferred embodiment of the present invention;

FIG. 3 is a cross-sectional view taken along the line III-III′ in FIG. 2

FIG. 4 is a perspective view showing a type frame assemble to a body;

FIG. 5 shows a marking apparatus imprinting an ink contained in a stamp;

FIG. 6 is a exploded perspective view of the stamp;

FIG. 7 shows a marking apparatus used in the preferred embodiment of the present invention;

FIG. 8 is a perspective view showing a line marker used in the preferred embodiment of the present invention;

FIG. 9 is a perspective view showing a storage box for accommodating the marking apparatus in accordance with the preferred example of the present invention;

FIGS. 10A to 10C is respectively a perspective view, a cross-sectional view and low view of a marking apparatus for a golf ball in accordance with another preferred example of the present invention;

FIG. 11 shows a marking apparatus imprinting a mark into a golf ball according to the preferred embodiment of the present invention;

FIG. 12 shows a type frame in accordance with the preferred embodiment of the present invention;

FIGS. 13A to 13B is respectively a perspective view and a cross-sectional view of a marking apparatus for a golf ball in accordance with still another preferred example of the present invention;

FIG. 13C shows a type-storage box provided on the marking apparatus in accordance with the preferred example of the present invention;

FIG. 14 is a perspective view of a marking apparatus for a golf ball in accordance with further still another preferred example of the present invention; and

FIG. 15 shows a stamp in accordance with the present invention.

### DETAILED DESCRIPTION OF THE ILLUSTRATED EMBODIMENTS

Reference will now be made in detail to the illustrated embodiment of the present invention, which is illustrated in the accompanying drawings.

### Example 1

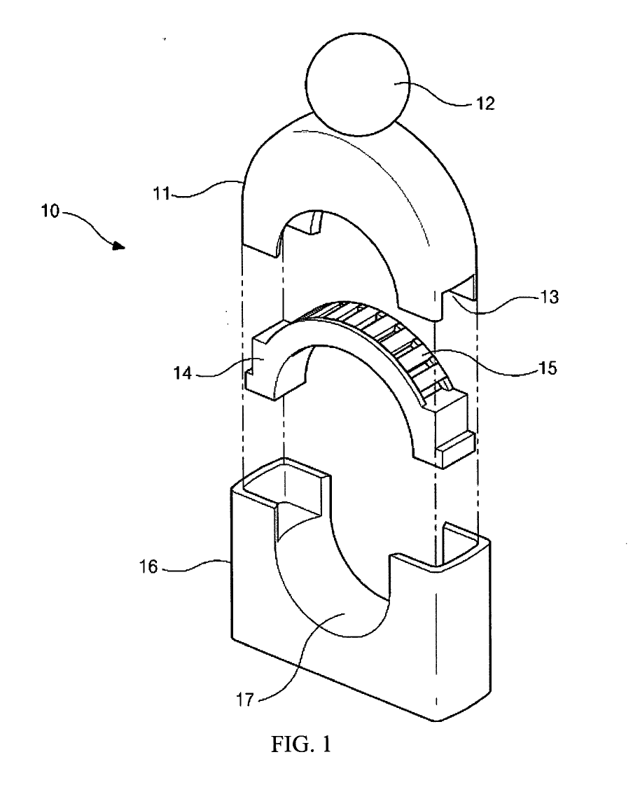

FIG. 1 is an exploded perspective view showing a marking apparatus 10 for a golf ball according to one preferred example of the present invention. As shown in FIG. 1, the marking apparatus 10 comprises an arc-shaped body 11 having a predetermined thickness, a type frame 14 joined into the arc-shaped body 11, and a base 16 having a resting plane 17 of a second curved surface that has a curvature corresponding to the golf ball. The arc-shaped body 11 comprises a groove 13 formed circumferentially along the inside of the arc-shaped body 11 so that the type frame 14 can be inserted into the groove 13. Also, a handle 12 is joined onto the top of the arc-shaped body 11.

The type frame 14 has a thickness corresponding to the groove 13 of the arc-shaped body 11 so that it can be joined detachably into the groove 13. In this case, the type frame 14 is fastened conveniently in the groove 13 by means of a press fit.

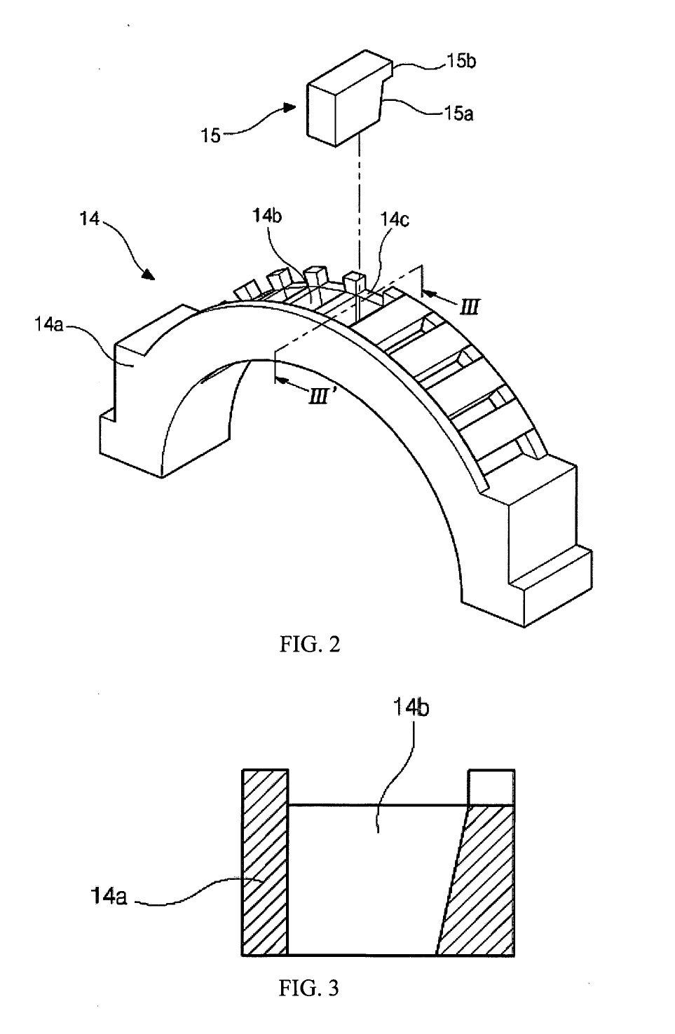

The type frame 14 comprises an arc-shaped frame 14a and plural insert-holes 14b passing through the arc-shaped frame 14a for inserting printing types 15, as shown in FIG. 2, which is a perspective view showing the type frame 14 in accordance with the preferred embodiment of the present invention. Preferably, the arc-shaped frame 14a has a first curved surface corresponding to the golf ball and each of the insert-holes passes through diametrically the arc-shaped frame 14a.

A printing type 15, which is inserted into each of the plural insert-holes 14b, comprises a printing-type body 15a, a protrusion 15b extended or jutted out at the top of the printing-type body 15a, and an embossing face (not shown in FIG. 2) embossing signs, characters, letters and the likes at the underside of the type-printing body 15a.

Preferably, a depressed groove 14c is formed on the top of each of the insert-holes 14b so that the protrusion 15b of the printing type 15 can be inserted onto the depressed groove 14c. The depressed groove 14c can be omitted depending on the shapes of the printing type 15. Users can insert the printing type 15 conveniently into each of the insert-holes 14b after picking up the protrusion 15a with tweezers.

Moreover, it is preferable that each of the insert-holes 14b has a shape tapered down, i.e. a tapered-shape toward the center of the arc-shaped frame 14a, as shown in FIG. 3, which is a cross-sectional view taken along the line III-III′ in FIG. 2. In this case, the printing type body 15a also a tapered-shape corresponding to the tapered insert-hole 14b so that the printing type 15 can be inserted into the insert-hole 14b conveniently.

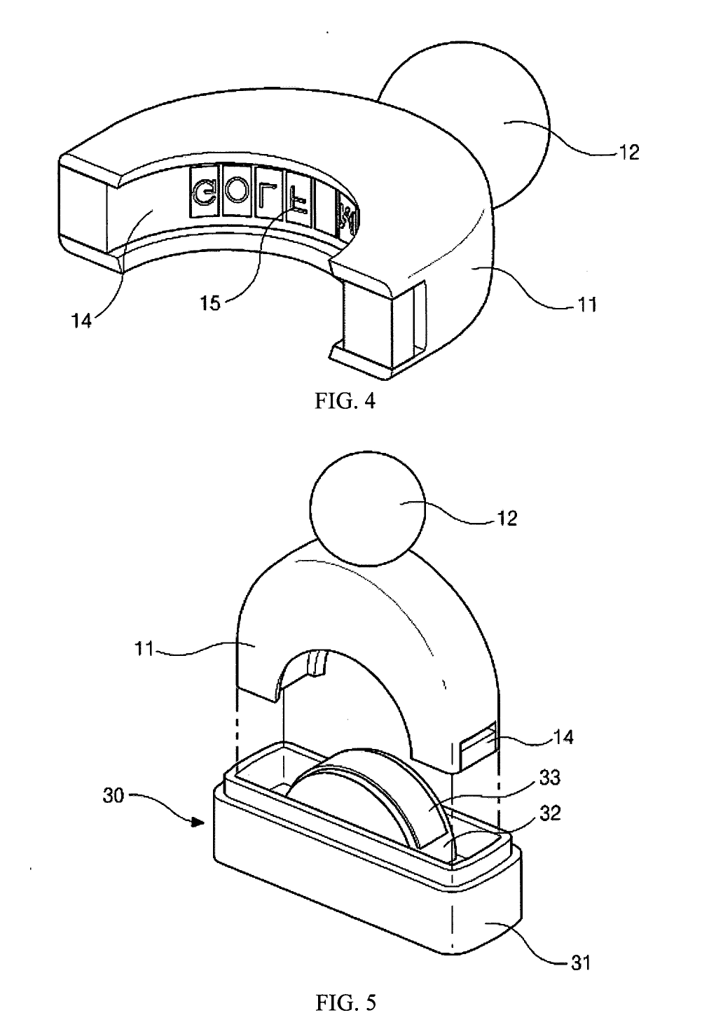

FIG. 4 is a perspective view showing the type frame 14 joined or assemble to the arc-shaped body 11. As shown the figure, a plurality printing types 15 are inserted into the type frame 14. Imprinting material such an ink is spread on the inserted printing type 15 so that the golf ball can be marked with the printing type 15.

FIG. 5 shows a marking apparatus spreading ink, which is contained in a stamp 30, on the printing type 15 in accordance with the preferred embodiment of the present invention. The stamp 30 comprises a stamp base 31, a stamp body 32 fixed onto the stamp-base 31 and having a curved surface corresponding to the type frame 14, and a stamp pad 33 attached onto the curved surface of the stamp body 32.

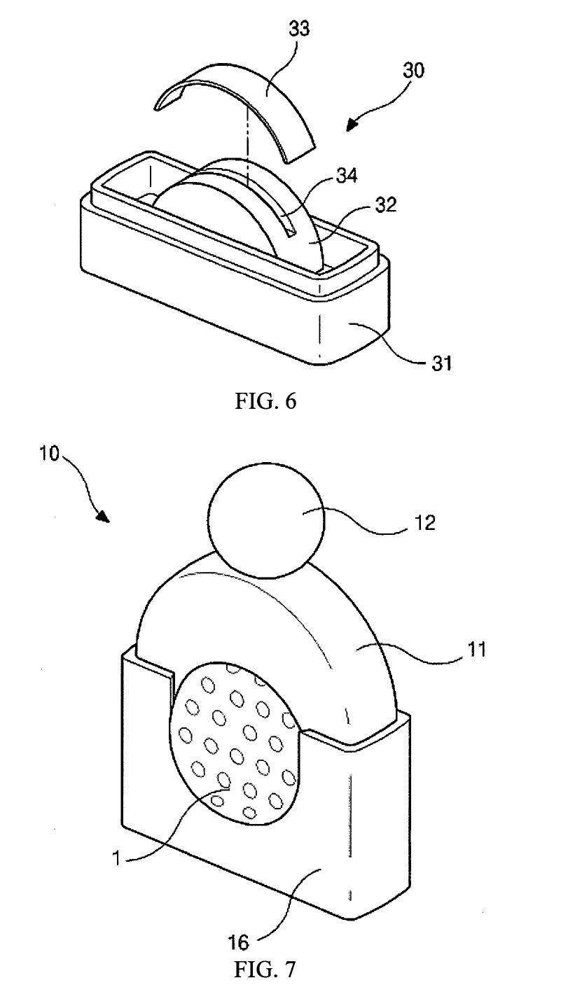

As shown in FIG. 6, which is an exploded perspective view of the stamp 30, the stamp body 32 has a through-hole 34 along the circumference of it. The through-hole 34 communicates with an ink-accommodation space within the stamp body 32. The stamp pad 33 of fibrous quality is attached onto the top of the through-hole 34 so that it is impregnated with ink provided from the ink-accommodating space.

The stamp body 32 may accommodate only ink, however, it is preferable that a filter is filled within the stamp body 32 and the filter is connected to the stamp pad 32 so that the filter is impregnated with ink. Accordingly, the ink can be provided effectively to the stamp pad 32 through the filter. In this case, since the stamp pad 32 contacts directly to the type frame 14, it requires some durability or endurance. Therefore, it is preferable that the stamp pad 32 may be made of felt.

It is possible to mark characters onto the golf ball that is grasped with one hand, while the marking apparatus 10 is taken by the other hand. However, it is preferable that the golf ball is rested on the golf-ball base 16 prior to marking characters onto the golf ball in order to marking unshakably and correctly as shown in FIG. 7, which shows a marking apparatus 10 used in the preferred embodiment of the present invention. In this case, a fixing pad made of high friction-coefficient material such as rubber may be attached on the resting plane 17 of the golf-ball base 16 in order to preventing the golf ball from shaking.

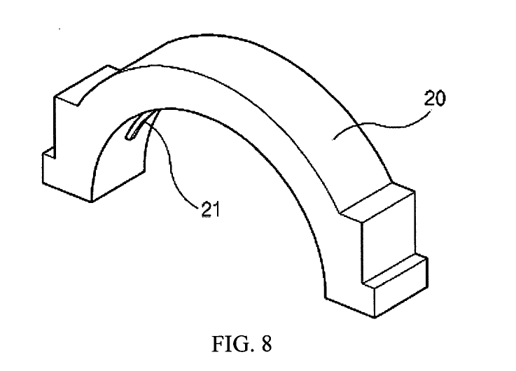

Users can mark characters, letters, or signs onto the golf ball with printing types inserted into the above-described marking apparatus. However, the marking apparatus of the present invention can be used to mark a putting line for exercising putting. In this case, a line marker 20 can be used in the marking apparatus instead of the typing frame, as shown in FIG. 8, which is a perspective view showing the line marker 20.

The line marker 20 has an arc-shaped frame as the frame 14a of the above-described type frame 14, however, it is characterized that a protrusion 21 is formed along the underside of the arc-shaped frame, instead of the insert-hole.

Therefore, when users intend to mark a putting line on the golf ball, the line marker 20 instead of the type frame 14 is joined to the body 11 of the marking apparatus 10 and then imprinting material such ink is spread on the protrusion through the stamp 30 so that the putting line can be marked on the golf ball.

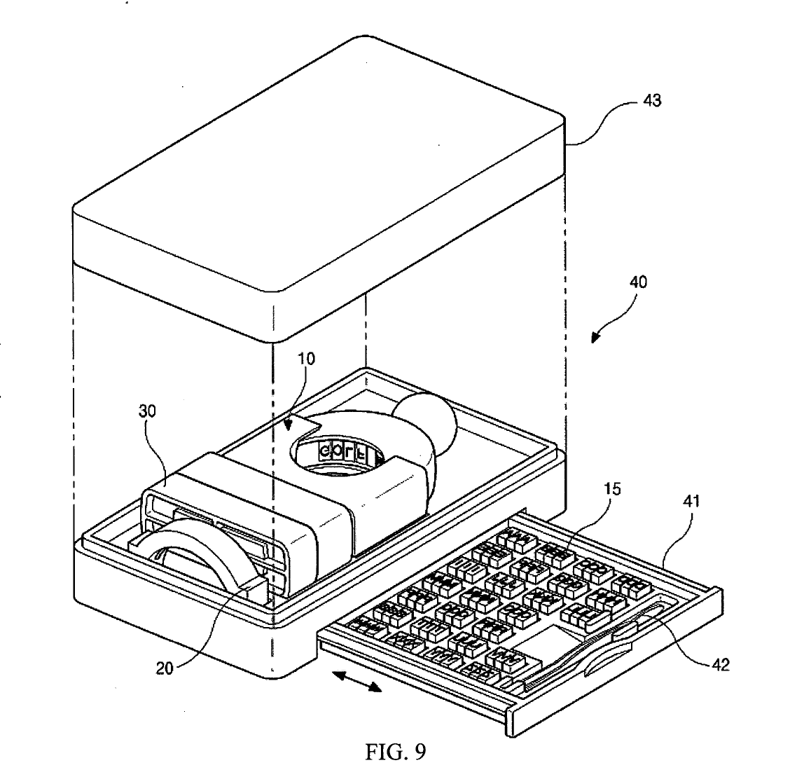

The above-described marking apparatus 10 for golf balls, the line marker 20 and the stamp 30 may be prepared as a set, and therefore they can be provided in the storage box 40, as shown in FIG. 9, which a perspective view showing the storage box 40 for accommodating the marking apparatus 10, the stamp 30 and the likes in accordance with the preferred embodiment of the the present invention.

The storage box 40 accommodates the golf-ball marking apparatus 10, the line marker 20, and the stamp 30. Preferably a printing-type holder 41 of a sliding type is joined to the side of the storage box 40. The printing-type holder 41 accommodates not only the printing type 15 but also the tweezers 42 for picking up each of the printing type 15. Besides, a lid 43 is joined to the top of the storage box 40.

### Example 2

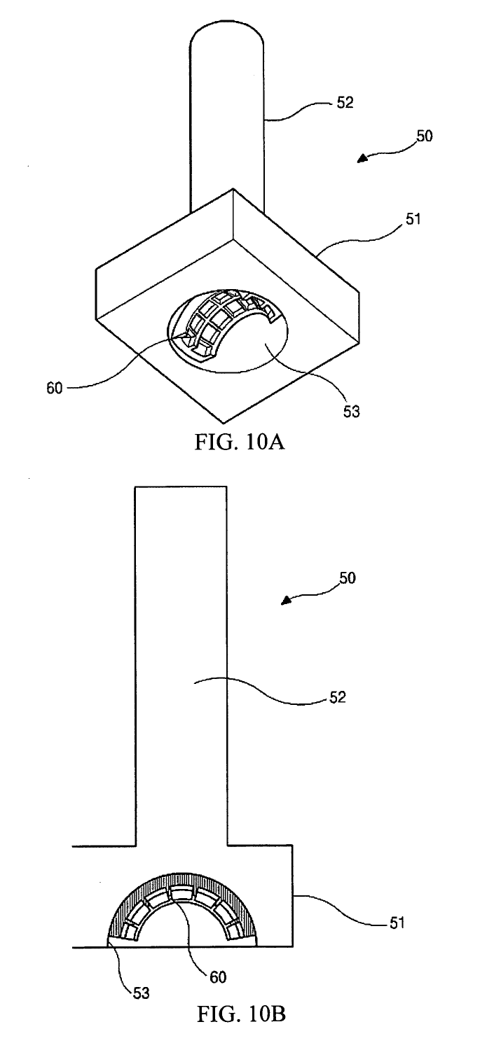

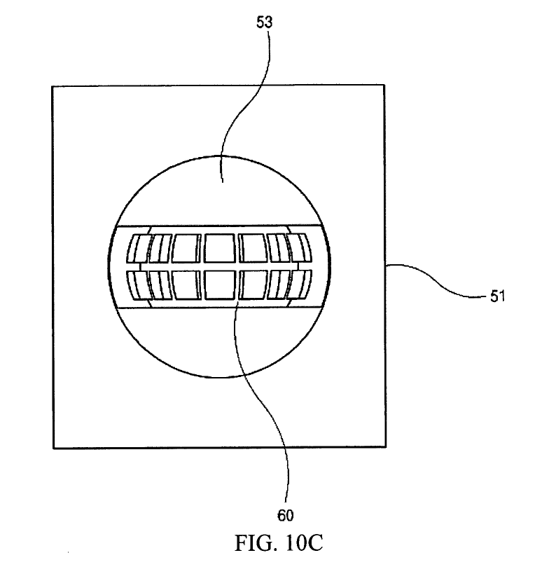

FIGS. 10A to 10C is respectively a perspective view, a cross-sectional view and a bottom view of a marking apparatus 50 for a golf ball in accordance with another preferred example of the present invention. The marking apparatus 50 comprises a body 51 of a square-pillar form, a concave surface 53 that has a curvature corresponding to the golf ball and is formed on one side, preferable the underside of the body 51, and a type frame 60 fixed within the concave surface 53.

In the marking apparatus 10 according to the first example above, the type frame 14 or the line marker 20 is joined detachably to the arc-shaped body 11, while it is characterized that the type frame 60 is fixed within the body 51 of the marking apparatus 50 in accordance with the second example. Therefore, the printing type is inserted upwardly into the type frame 60.

In the present example, the shape of the body 51 is not restricted to the square pillar as shown in FIG. 10A. The body 51 may have a post-shape such as a polygonal pillar or a cylinder or a hemispherical shape of thin film. Besides, the body 51 has an arc shape with a predetermined width as mentioned above in the first example. The handle 52 may be joined onto the body 51 so that users can grip conveniently the marking apparatus 50 by the handle 52.

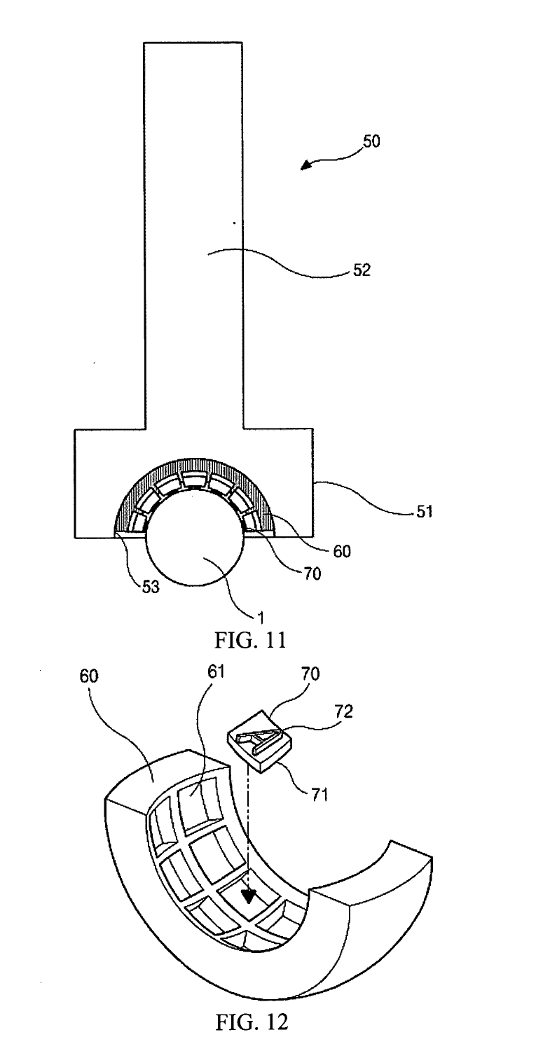

FIG. 11 shows the marking apparatus 50 imprinting an indicator to a golf ball according to the preferred embodiment. As shown in FIG. 11, the golf ball 1 is inserted within the type frame 60. In this case, since the outer surface of the golf ball 1 should contact closely to the printing type 70, which is fixed within the type frame 60, the type frame 60 must have a curvature corresponding to or the same as the golf ball 1. On the other hand, the concave surface 53 may have a depth enough to accommodate the golf ball.

FIG. 12 shows a part of the type frame 60 that is fixed onto the concave surface 53. As shown in FIG. 12, the type frame 60 has a curvature corresponding to the golf ball and comprises a plurality of insert-holes 61 each of which can insert detachably a printing type 70 respectively. The insert-hole 61 may have a structure of a through-hole or a depressed groove/slot and it is not restricted to the quadrangular shape as shown in FIG. 12. The type frame 60 has a length depending upon the number of the insert-hole 61, preferably, it may have a length capable of forming 10˜20 insert-holes.

Since the printing type 70, which is inserted within the insert-hole 61, shall not be taken off the insert-hole 61 of itself, it is preferable that the printing type 70 is a little bit wider than the insert-hole 61 and the printing type 70 can be inserted within the insert-hole 61 by means a press fit. For facilitating the insertion of the printing type 70 into the insert-hole 61, it is preferable that the type frame 60 may be made of elastic material such as rubber.

Instead of attaching the separately-manufactured type frame 60 into the concave surface 53, it is possible to process the inside of the concave surface 53 so as to form the insert-hole that is capable of inserting the printing type 70.

The printing type 70 is intended to indicate a discernable mark onto the golf ball. Accordingly, the printing type 70 may be any symbol, for example, a character, a letter, a number, a sign, a figure, a diagram, and the likes. Especially, the printing type 70 may have a curvature corresponding to or approximately the same as the type frame 60 or the surface of the golf ball because it shall contact closely to the golf ball.

As shown in FIG. 12, the printing type 70 comprises a type body 71, and an embossing face 72, which embosses a sign, a letter, a character, a number, or a figure with an inverse image on one surface of the type body 71. Since the type body 71 can be inserted detachably within the type frame 60 by means of a press fit, it is preferably made of material with some elasticity and durability. Besides, since the embossing face 72 contacts closely to the curved surface of the golf ball, it has a curved top-surface with a curvature corresponding to or substantially the same as the golf ball.

Moreover, plural dimples are formed on the outer surface of the golf ball in order to reduce air resistance. Therefore, the embossing surface 72 is preferably made of elastic material such as rubber so that the top surface of the embossing surface 72 may contact closely to the plural dimples and thereby imprinting the type correctly onto the golf ball. In addition, imprinting material such as ink should be spread onto the printing type 70 prior to fixing the printing type 70 within the type face 60 and marking the printing type onto the golf ball.

Generally, many kinds of printing types 70 can be attached into the type face 60 and it is cumbersome for users to carry separately spreading means or material such as ink or a roller. Therefore, it is possible to carry the spreading means or material with the marking apparatus 50 by preparing a space for storing the spreading means or material within the body 51 or the handle 52.

### Example 3

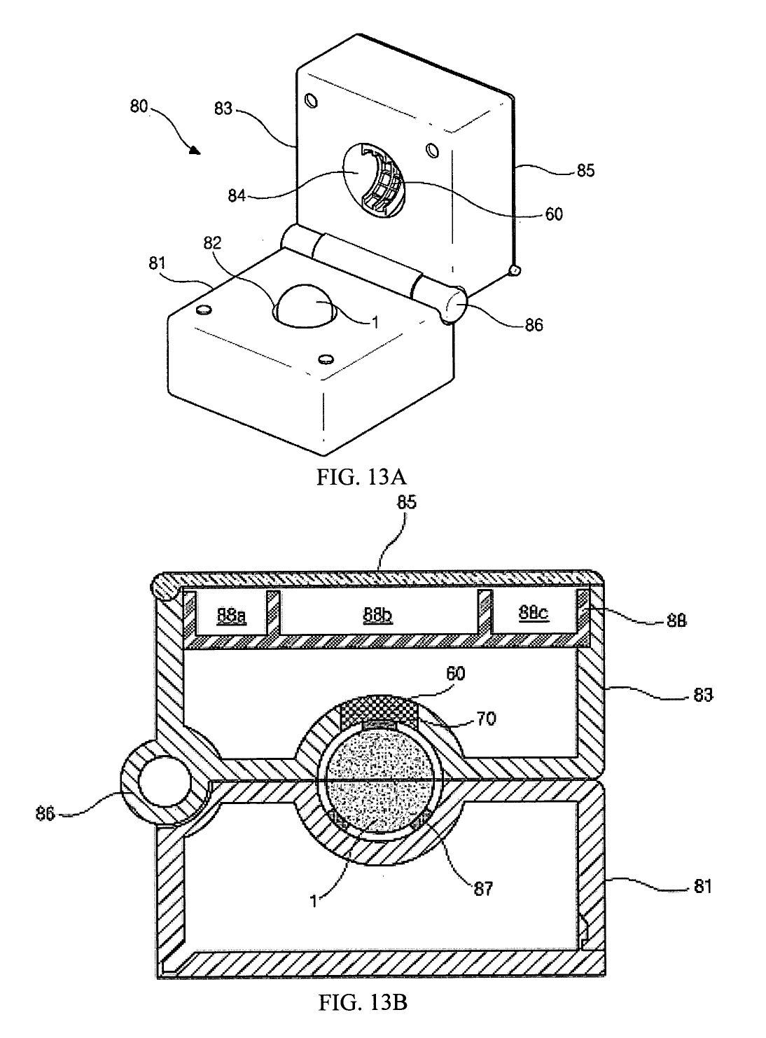

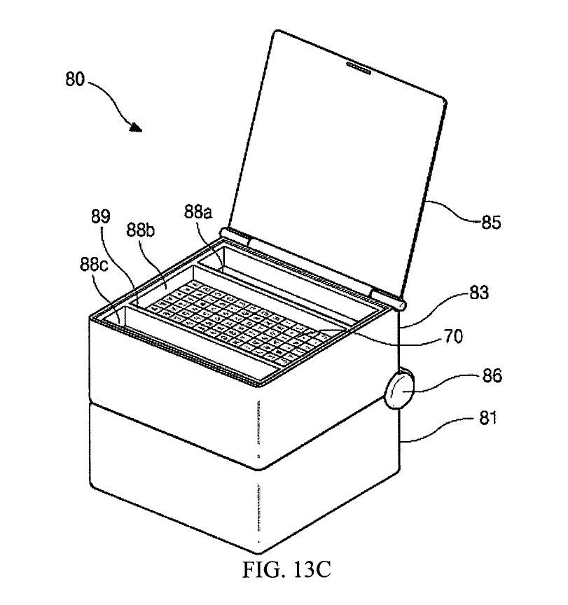

FIGS. 13A to 13B is respectively a perspective view and an assembled cross-sectional view of a marking apparatus 80 for the golf ball in accordance with still another preferred example of the present invention. As shown the figures, the marking apparatus 80 comprises a resting base 81 that has a resting groove 82 of a concave curved surface (a second curved surface) for inserting the golf ball 1, a body 83 comprising a concave surface 84 enclosing the golf ball together with the curved surface of the resting groove 82 and a hinge 86 to join the base 81 and the body 83 together.

The shape of the body 83 and the base 81 is not restricted to the square pillar as shown in FIG. 13A, but may have a post-shape such as a polygonal pillar or a cylinder or a hemispherical shape of thin film, as mentioned above.

Preferably, the resting groove 82 may have a curved surface of a curvature corresponding to or substantially the same as the golf ball 1, and more preferably, a fixing pad 87 is attached to the inside of the resting groove 82 so that it contacts closely to the outer surface of the golf ball and thereby preventing the golf ball from moving.

The fixing pad 87 may be made preferably of material with high friction coefficient such as rubber. However, instead of attaching the fixing pad 87, it is also possible to prevent the movement of the golf ball by treating the inside of the resting groove 82 in order to have high surface roughness. The concave surface 84, the type frame 60 fixed within the concave surface 84, and the printing type 70 is the same as mentioned above in Example 2.

Moreover, users should carry not only the marking apparatus 80 also imprinting means such as plural printing types 70 used in the marking apparatus 80, imprinting material such as ink spread onto the printing type 70 and the roller for spreading. In this case, since it is cumbersome for users to carry the spreading means, it is preferable that means for storing the spreading means is prepared used together with the marking apparatus 80.

FIG. 13C shows a storage box 88 prepared with the marking apparatus 80 in accordance with the preferred embodiment of the present invention. Referring to FIG. 13C, the storage box 88 is formed on the top of the body 83. The storage box 88 is partitioned into a roller storage area 88a, a printing-type storage area 88b and an ink storage area 88c with a separator 89. Also, a cover 85 is joined onto the storage box 88 by a hinge.

The ink storage area 88c accommodates an ink tube for spreading ink onto the printing type 70, the roller storage area 88a accommodates a mini-sized roller or a brush for spreading ink prepared from the ink tube, and the printing-type storage area 88b accommodates plural printing types 70 each of which is a sign, a character, a letter, a number, or a figure embossed with an inverse image.

It is only an exemplary that the storage box 88 is joined onto the top of the body 83. The storage box 88 may be joined to the underside of the base 81 or the outer side of the body 83 or the base 81. Also, the storage box 88 may not be partitioned into separated plural areas as shown in FIG. 13C.

### Example 4

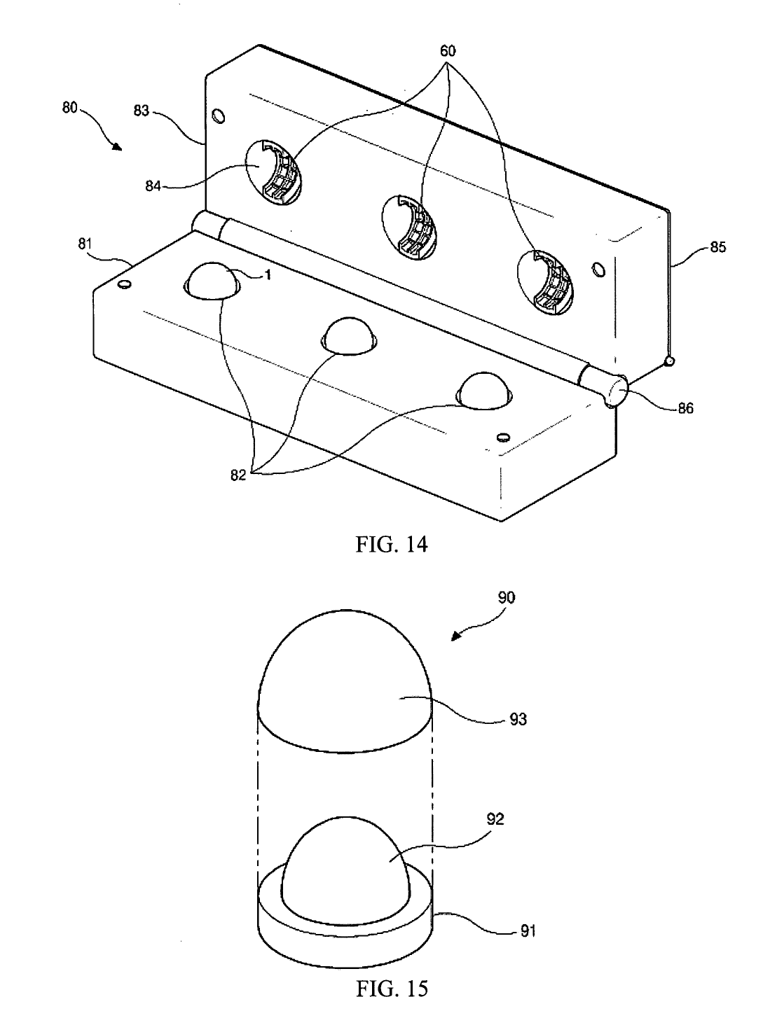

FIG. 14 is a perspective view of a marking apparatus for a golf ball in accordance with further still another example of the present invention. The marking apparatus 80 has a similar structure as described above in example 3, that is, the marking apparatus 80 comprises a golf-ball base 81 that forms several, e.g. two, three or four, and preferably three, resting grooves 82, and a body 83, which has preferably three concave surfaces 84 corresponding to each of the resting groove 82. The marking apparatus can accommodate plural golf ball simultaneously and mark desired symbols, such as characters, letters, or numbers, onto the golf balls.

In addition, imprinting material such as ink has to be spread on the printing type 70 inserted into the type frame 60 in order to mark discernable symbols onto the golf ball with using the marking apparatuses 50 and 80 in accordance with preferred examples 2 to 4. For spreading ink, a mini-sized roller may be used as mentioned above. However, a stamp may be used preferably. FIG. 15 shows a stamp 90 in accordance with the present invention. Hereinafter, the stamp 90 will be described with referring to FIGS. 13A to 14 which describe the preferred examples 3 and 4.

The stamp 90 comprises a stamp body 91 that forms a curved surface of a curvature corresponding to or substantially the same as the type frame 84 fixed within the concave portion 84 of the body 83, a stamp pad 92 attached onto the curved surface of the stamp body 91 and impregnated with ink, and a stamp lid 83 for preventing ink from evaporating from the stamp pad 92.

The curved surface of the stamp body 91 may have various shapes as long as it makes the printing type 70 spread with ink. Preferably, the curved surface of the stamp body 91 may have a hemispherical shape, or an arc shape as shown in FIG. 5.

The stamp body 91 forms an ink-accommodating space within it, and a through-portion communicating the ink-accommodating space with the stamp pad 92, and thereby providing ink continuously with the stamp pad 92.

The stamp lid 93 may be joined to the stamp body 91 by means a press fit or by a hinge.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A marking apparatus for a golf ball, the apparatus comprising:
a body; and
an imprinter joined to the body and having a first curved surface corresponding to the golf ball.

2. The marking apparatus according to claim 1, wherein the imprinter comprises an arc-shaped frame having a predetermined thickness and a curvature corresponding to the golf ball, a type frame joining detachably to the body and having an insert-hole passing through the arc-shaped frame, and a printing type inserted into the insert-hole.

3. The marking apparatus according to claim 2, wherein the insert-hole passes diametrically through the arc-shaped frame.

4. The marking apparatus according to claim 2, wherein the body has a groove for inserting the arc-shaped frame.

5. The marking apparatus according to claim 2, wherein the insert-hole forms a tapered shape toward the center of the arc-shaped frame.

6. The marking apparatus according to claim 4, wherein the printing type has a tapered shape corresponding to the insert-hole.

7. The marking apparatus according to claim 1, wherein the imprinter comprises an arc-shaped frame having a predetermined thickness and a curvature corresponding to the golf ball, and a protrusion formed circumferentially along the arc-shape frame, wherein the imprinter is joined detachably to the body.

8. The marking apparatus according to claim 7, wherein the body has a groove in order to insert the arc-shaped frame.

9. The marking apparatus according to claim 1, wherein the body has a groove, wherein the imprinter is fixed in the groove and comprises a plurality of insert-holes.

10. The marking apparatus according to claim 1, further comprising a base, wherein the base comprises a second curved surface accommodating the golf ball together with the first curved surface.

11. The marking apparatus according to claim 10, wherein the base is joined to the body by a hinge.

12. The marking apparatus according to claim 10, wherein the base comprises a pad attached to the second curved surface for preventing a movement of the golf ball.

13. The marking apparatus according to claim 10, wherein the base comprises plural second curved surface and the body comprises plural imprinters, wherein each of the plural imprinters is corresponding to each of the second curved surfaces.

14. The marking apparatus according to claim 1, further comprises a stamp spreading an ink to the imprinter, wherein the stamp comprises a stamp body with a curved top corresponding to the first curved surface, a passing portion formed on the stamp body, and a stamp pad attached to the curved top of the stamp body.

15. The marking apparatus according to claim 14, wherein the stamp body further comprises an ink-accommodating area, wherein the passing portion is connected to the ink-accommodating area.

16. The marking apparatus according to claim 15, wherein the ink-accommodating area is filled with a filter and the stamp pad is made of felt.

17. A stamp for spreading ink to the imprinter of the marking apparatus according to claim 1, wherein the stamp comprises a stamp body with a curved top corresponding to the first curved surface, a passing portion formed on the stamp body, and a stamp pad attached to the curved top of the stamp body.

18. The stamp according to claim 17, wherein the stamp body further comprises an ink-accommodating area, wherein the passing portion is connected to the ink-accommodating area.

19. The stamp according to claim 18, wherein the ink-accommodating area is filled with a filter.

20. The stamp according to claim 17, wherein the stamp pad is made of felt.
